(19) United States
(12) Patent Application Publication
(10) Pub. No.: US 2003/0211827 A1
(43) Pub. Date: Nov. 13, 2003

(54) Repeater for radio communication system

(76) Inventors: Kenya Yonezawa, Kamifukuoka (JP); Feng Lu, Kamifukuoka (JP); Yoshio Kunisawa, Kamifukuoka (JP); Hiroyasu Ishikawa, Kamifukuoka (JP); Hideyuki Shinonaga, Kamifukuoka (JP)

Correspondence Address: LACKENBACH SIEGEL MARZULLO, ARONSON & GREENSPAN, P.C., Penthouse Suite, One Chase Road, Scarsdale, NY, 10583, US

(21) Appl. No.: 10/425,265

(22) Filed: Apr. 29, 2003

(30) Foreign Application Priority Data
May 7, 2002 (JP) 2002-131430

(51) Int. Cl. H04B 3/36; H04B 7/14

(52) U.S. Cl. 455/7; 455/11.1

(57) ABSTRACT

The invention offers a repeater for radio communication system for eliminating a blind zone in a closed space in the radio communication system, which transmits information between a base station and a mobile station over a radio transmission medium. The repeater comprises a base station-directed unit equipped with a function of transmitting a radio signal to and receiving a radio signal from said base station, and a mobile station-directed unit equipped with a function of transmitting a radio signal to and receiving a radio signal from said mobile station. The base station-directed unit and the mobile station-directed unit are connected via a radio transmission medium over which an electromagnetic wave signal is transmitted.

### BACKGROUND OF THE INVENTION

1. Technical Field of Invention

The present invention relates to a repeater employed for a solution of problems on a blind zone in a building, underground shopping center or similar closed space, where desirable radio waves cannot be received in a radio system, in which each mobile station is linked through radio transmission medium to a communicable base station.

2. Prior Art

Conventionally, a repeater is used in a building, underground shopping center or tunnel to which radio waves from a radio base station are not arrived in good transmission quality. The repeater is employed to establish radio communications between a base station and a mobile station via an antenna communicating with a base station (hereinafter referred to as a “base station-directed antenna”) and placed, for example, on the rooftop of a building where radio waves from the base station can be readily received.

FIG. 4 is a block diagram illustrating a system configuration of a conventional repeater, which is used as measures directed toward the elimination of a blind zone in a closed space. Reference numeral 1 denotes a radio base station, 2 a service area of the radio base station 1, 3 a repeater, 4 a unit provided for communication with the base station 1 (hereinafter referred to as a “base station-directed unit”), 5 a unit provided for communication with a mobile station (hereinafter referred to as a “mobile station-directed unit”), 6 a service area of the repeater 3, 9 a mobile station, 10 a building, 11 an antenna directed to the base station 1 for communication therewith, 12 an antenna directed at the mobile station 9 for communication therewith the mobile station (hereinafter referred to as a “mobile station-directed antenna”), and 13 a coaxial cable.

In this system, a signal from the radio base station 1 is received by the base station-directed antenna 11 placed in the service area 6 of the repeater 3 and amplified to a predetermined level, thereafter being retransmitted toward a blind zone via the mobile station-directed antenna 12. On the other hand, a signal from the mobile station 9 is received by the mobile station-directed antenna 12 of the repeater 3 and amplified to a predetermined level, thereafter being retransmitted toward the radio base station 1 via the base station-directed antenna 11. With such an arrangement, the repeater 3 extends the service area 2 of the radio base station 1 to the closed space in the building 10, making it possible to offer communication services to the mobile station 9 in the closed space 6.

In FIG. 4, the base station-directed antenna 11 is placed outdoors or at the window. If the mobile station-directed antenna 12 is placed near the base station-directed antenna 11, the signal from the latter is received by the former, resulting in serious deterioration of the communication. This phenomenon is called a sneak path. This sneak path constitutes a coupled loop [base station-directed antenna 11→base station-directed unit 4→coaxial cable 13→mobile station-directed unit 5→mobile station-directed antenna 12→base station-directed antenna 11]. In this case, even when the gain of this coupled loop is zero or minus, the communication quality is degraded by an echo, whereas when the gain of the loop is plus, an oscillation phenomenon occurs, making the entire communication system inoperative. The influence of the sneak path could be excluded by installing the base station-directed unit 4 and the mobile station-directed unit 5 at a necessary distance from each other, or the mobile station-directed unit 5 and the mobile station-directed antenna 12 at a necessary distance from the base station-directed unit 4 and the base station-directed antenna 11, in which case, however, a coaxial cable of several tens of meters long is needed to interconnect the base station-directed unit 4 and the mobile station-directed unit 5 or the mobile station-directed unit 5 and the mobile station-directed antenna 12. The installation of the coaxial cable 13 will inevitably raise the total cost of the repeater.

A repeater with an interference canceller equipped with a sneak path-eliminating or compensating function is now under development, but low-cost repeater with an interference canceller has not yet reached an adequate level for practical use. Furthermore, implementation of the interference canceller by the use of digital signal processing techniques is accompanied by a delay in processing, which may impose limitations on the distance between the location of the repeater and the base station.

FIG. 5 depicts an example of the configuration of a conventional repeater 100. As shown in FIG. 5, the repeater 100 comprises a base station-directed antenna 71, a base station-directed unit 72, a mobile station-directed unit 73, and a mobile station-directed antenna 74. The base station-directed unit 72 and the mobile station-directed unit 73 are mutually connected by a coaxial cable or similar cable transmission medium (L1, L2) for transmission of electric signals. In the base station-directed unit 72, reference numeral 75 denotes a duplexer provided for communication with the base station (hereinafter referred to as a “base station-directed duplexer”), 76 a down-link LNA (Low Noise Amplifier), and 80 an up-link HPA (High Power Amplifier). In the mobile station-directed unit 73, reference numeral 77 denotes a down-link HPA, 78 a duplexer provided for communication with the mobile station (hereinafter referred to as a “mobile station-directed duplexer”), and 79 an up-link HPA. The down-link is formed by a route [base station-directed antenna 71→base station-directed duplexer 75→down-link LAN 76→cable transmission line L1→down-link HPA 77→mobile station-directed duplexer 78→mobile station-directed antenna 74]. The up-link is formed by a route [mobile station-directed antenna 74→mobile station-directed duplexer 78→up-link LNA 79→cable transmission line L2→up-link HPA 80→base station-directed duplexer 75→base station-directed antenna 71].

The conventional repeater 100 provided to solve the problem of blind zone in a closed space inevitably suffers a sneak-path interference, that a signal from the one antenna (71 or 74) is received by the other antenna (74 or 71). The measures taken against this interference raise the cost of installation of the repeater 100.

More specifically, in the repeater 100 the base station-directed unit 72 and the mobile station-directed unit 73, or the mobile station-directed unit 73 and the base station-directed antenna 72 are interconnected by the coaxial cable (L1, L2) of several tens of meters long so that the two antennas 71 and 74 are placed far apart; although the repeater itself is low-cost, the cost of the laying of the coaxial cable (L1, L2) greatly raises the total cost of the repeater. Moreover, there is a fear that the repeater cannot be installed if no permission to lay the coaxial cable (L1, L2) is given.

Furthermore, there is also being developed a repeater with an interference canceller equipped with a sneak path-removing or compensating function with a view to cutting the cost of the laying of the coaxial cable (L1, L2).

The interference canceller is composed of a system for estimating the characteristic of the propagation path between the base station-directed antenna and the mobile station-directed antenna, and a system for extracting a signal prior to its transmission from the transmitting antenna by a directional coupler. The extracted signal is multiplied by an inverse characteristic of the estimated propagation path characteristic to combine a compensating signal with an input signal. This involves real-time execution of complex processes such as the propagation path estimation, phase adjustment and so forth. On this account, a low-cost repeater with the interference canceller has not yet attained a sufficient level for practical use. Additionally, in case of implementing the interference canceller by the use of digital signal processing techniques, a delay develops in processing, arising a fear of imposing des-practicable limitations on a distance between the location of the repeater and the base station.

### SUMMARY OF THE INVENTION

An object of the present invention is to provide a low-cost repeater for use in a closed space which overcomes the above-mentioned problems of the prior art and hence is low in the cost of installation and small in the processing delay.

To attain the above object, a repeater for radio communication system according to the present invention, is proposed for solving the problem of blind zone in a closed space, and is characterized in that, for a down link:

a base station-directed unit comprises: a receiving function of receiving a radio-frequency signal from a base station and taking out the received signal; a signal converting function of converting the received signal to an electromagnetic wave signal of a different frequency band or different media; and a repeating/transmitting function of transmitting the frequency-converted or media-converted electromagnetic wave signal over a radio transmission medium; and

a mobile station-directed unit comprises: a repeating/transmitting function of receiving the transmitted electromagnetic wave signal; a signal regenerating function of regenerating the frequency of the received electromagnetic wave signal to the frequency of the radio-frequency signal received by the base station-directed unit or regenerating the received media-converted electromagnetic wave signal to the frequency of the radio-frequency signal received by the base station-directed unit, and a transmitting function of amplifying and transmitting the regenerated received signal to a mobile station.

For an up link, the repeater according to the present invention is characterized in that:

a mobile station-directed unit comprises: a receiving function of receiving a radio-frequency signal from a mobile station and taking out the received signal; a signal converting function of converting the received signal to an electromagnetic wave signal of a different frequency band or different media; and a repeating/transmitting function of transmitting the frequency converted or media-converted electromagnetic wave signal over a radio transmission medium; and

a base station-directed unit comprises: a repeating/transmitting function of receiving the transmitted electromagnetic wave signal; a signal regenerating function of regenerating the frequency of the received electromagnetic wave signal to the frequency of the radio-frequency signal received by the base station-directed unit or regenerating the received media-converted electromagnetic wave signal to the frequency of the radio-frequency signal received by the base station-directed unit; and a transmitting function of amplifying and transmitting the regenerated received radio-frequency signal to a base station.

The frequency to which the received signal is converted in the present invention can be so chosen as to form a different communication channel of the radio system for which the repeater is provided.

Further, the frequency to which the received signal is converted can be so chosen as to form a communication channel of a 2.4 GHz band or the like in a radio system different from that for which the repeater is provided.

The media to which the received signal is converted in the present invention may be a media, which transmits an infrared-ray signal as of a 1.5 μm band.

The media to which the received signal is converted may also be a media, which transmits an optical radio signal as of a 800 nm wavelength.

### BRIEF DESCRIPTION OF THE DRAWINGS

Other objects, features and advantages of the present invention will become more apparent from the following description taken in conjunction with the accompanying drawings, in which:

FIG. 1 is a block diagram illustrating an example of the configuration of a repeater according to the present invention applied to a solution of the blind-zone problem in a closed space;

FIG. 2 is a diagram depicting another example of a repeater according to the present invention using a radio media applied to a solution of the blind-zone problem in a closed space;

FIG. 3 is a diagram showing another example of a repeater according to the present invention using an infrared-ray communication or optical wireless media applied to a solution of the blind-zone problem in a closed space;

FIG. 4 is a diagram showing the system configuration of a conventional repeater; and

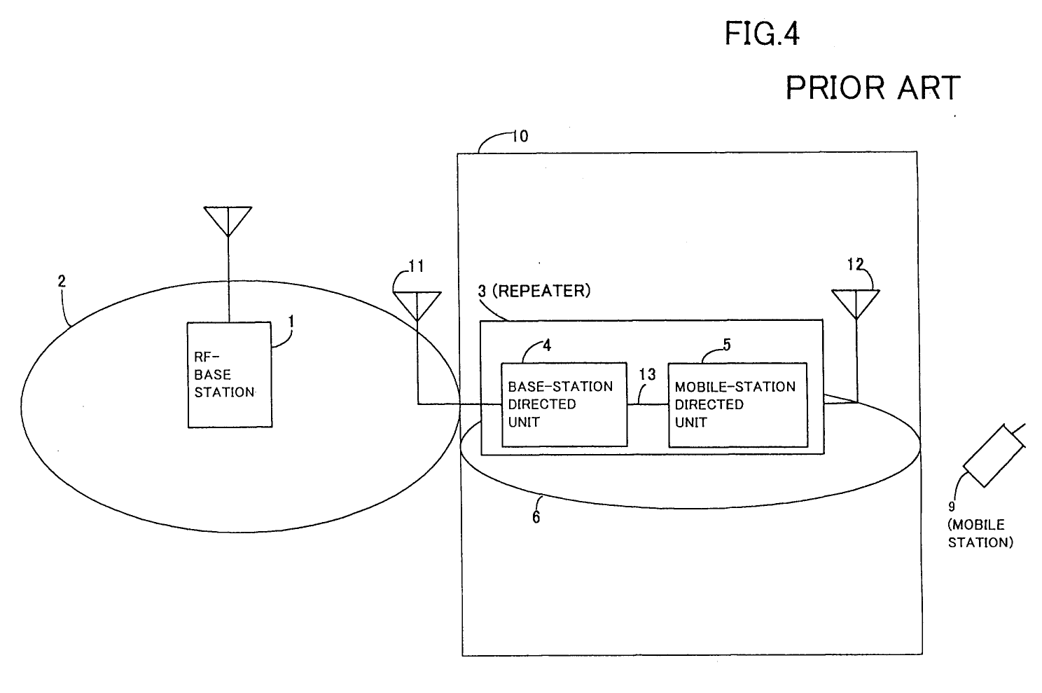

FIG. 5 is a diagram depicting an example of the configuration of another conventional repeater.

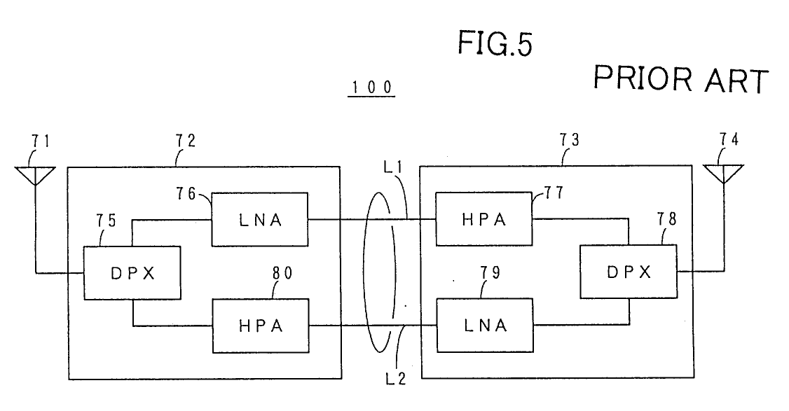

### DETAILED DESCRIPTION OF THE INVENTION

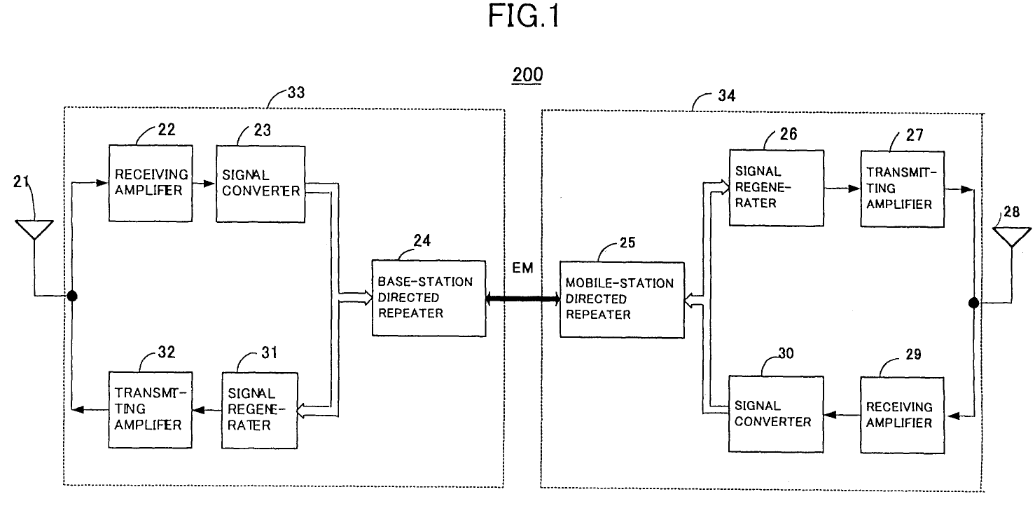

FIG. 1 illustrates an example of the configuration of a repeater 200 according to the present invention applied to a solution of the blind-zone problem in a closed space. In FIG. 1, the repeater 200 comprises a base station-directed antenna 21, a base station-directed unit 33, a mobile station-directed unit 34, and a mobile station-directed antenna 28.

A description will be given first, with reference to FIG. 1, of a signal flow in a down link over which a signal is transmitted from the base station to the mobile station.

The down-link signal from the base station is received by the base station-directed antenna 21 and amplified by a down-link receiving amplifier 22. Next, the amplified received signal is frequency- or media-converted by a down-link signal converter 23 and the converted signal is transmitted from a base station-directed repeater 24 to the mobile station-directed unit 34. In the mobile station-directed repeater 34, the signal transmitted from the base station-directed unit 33 is received by a mobile station-directed repeater 25, and the received signal is regenerated by a down-link signal regenerator 26. The regenerated signal is amplified by a down-link transmitting amplifier 27 and transmitted over a radio transmission medium EM from the mobile station-directed antenna 28.

As is the case with the above processing of the down-link signal, an up-link signal for transmission from a mobile to a base station is received by the mobile station-directed antenna 28 and amplified by an up-link receiving amplifier 29. Next, the amplified signal is frequency- or media-converted by an up-link signal regenerator 30, and the converted signal is transmitted over the radio transmission medium EM from the mobile station-directed repeater to the base station-directed unit 33. In the base station-directed unit 33, the signal transmitted over the radio transmission medium EM from the mobile station-directed unit 34 is received by a base station-directed repeater 24 and then regenerated by an up-link signal regenerator 31 to a signal of the system used. The regenerated signal is amplified by an up-link transmitting amplifier 32 and radiated from the base station-directed antenna 21.

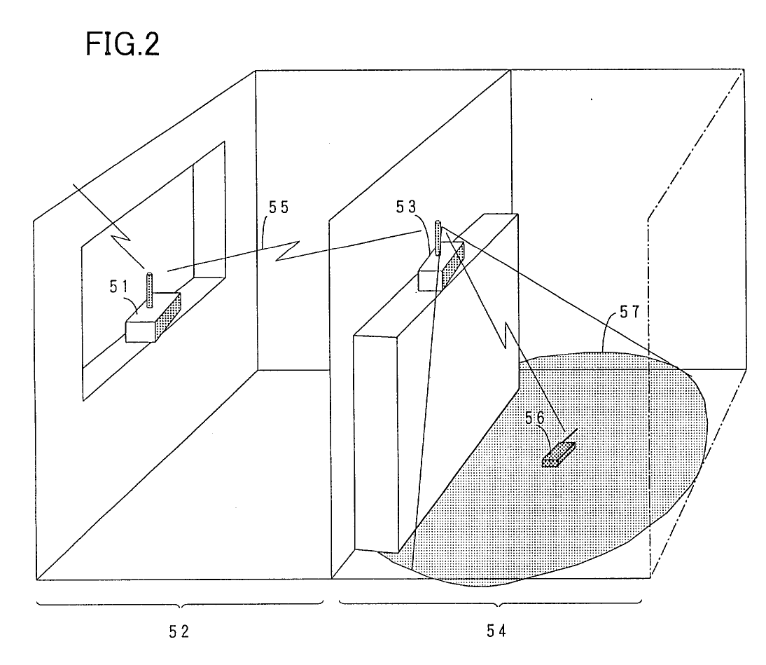

FIG. 2 shows an example of the installation of a repeater according to the present invention using a radio media. In FIG. 2, a base station-directed unit 1, which corresponds to the base station-directed unit 33, is placed in a room 52 communicable with the base station, and a mobile station-directed unit 51, which corresponds to the mobile station-directed unit 34, is placed in a room 54 in a blind zone. The base station-directed unit 51 and the mobile station-directed unit 53 are linked via the radio transmission medium EM over which a frequency-converted radio repeating signal (an electromagnetic wave signal) 55 is transmitted. Since the radio repeating signal 55 is capable of passing through walls, floors and so forth, a plurality of rooms or floors can be provided as a service area, for instance, by using one base station-directed unit and a plurality of mobile station-directed units.

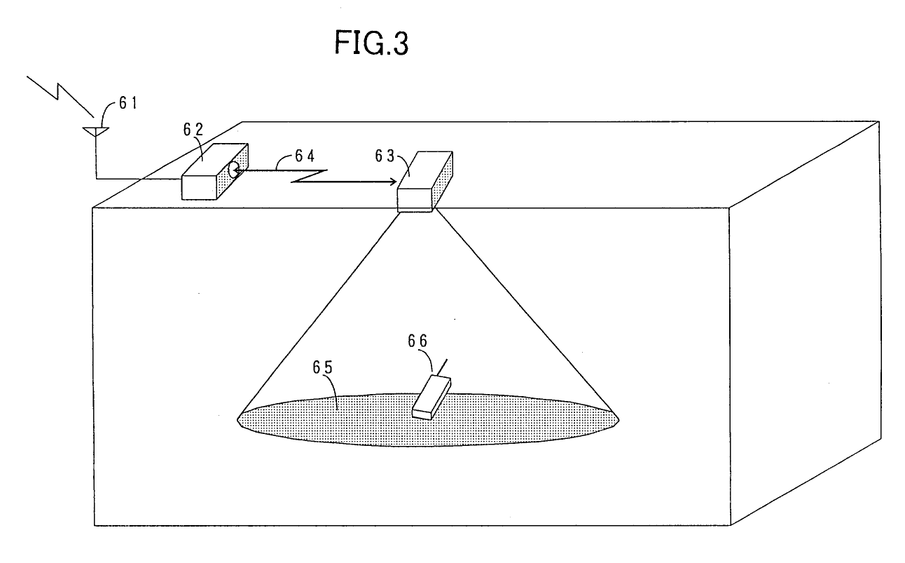

FIG. 3 is an example, of installation of a repeater according to the present invention using an infrared-ray communication or optical wireless media. For example, in an underground shopping center, a base station-directed antenna 61 is placed on the ground, and a base station-directed unit 62 placed at one end of the ceiling of the underground shopping center and a mobile station-directed unit 63 provided at the center of the ceiling of the underground shopping center are interlinked via the radio transmission medium EM over which an infrared-ray or repeated light wave (an electromagnetic wave signal) 64 is transmitted; this permits communications in a service area 65 extended by the repeater. With the base station-directed unit 62 and the mobile station-directed unit 63 placed at a high position such as on the ceiling of the underground shopping center as described above, humans and articles do not intercept the repeated signal, and further, since the signal is an optical wireless signals, there is no need of taking into account he influence of reflection of the repeated signal by walls or the like.

As regards the gain of the coupling loop containing the “mobile station-directed antenna” and the “base station-directed antenna”, it is necessary to take measures directed toward the prevention of the gain from disturbing communications. The loss required of the coupling loop is a product of a desired carrier-to-interference wave ratio (CIR) of the system and the gain amplified by the radio repeating amplifier. For example, when the desired CIR is of 20 dB and the gain is of 60 dB, the antennas need to be isolated 80 dB or more.

This requirement could be satisfied by placing the base station-directed antenna and the mobile station-directed antenna in such a manner as not to be opposite each other. Since a distance between the antenna and the manner of their placement change with the frequency used, the location of their placement, antenna patterns used and so forth, a quantitative definition of the antenna distance is difficult; hence, the antennas need only to be placed, depending on trial-and-error methods to achieve the desired result. Further, since the materials, shapes and positions of shielding or screening members are preset in many cases, the direction of antennas and their distance need to be adjusted in accordance with such conditions. For example, the mobile station-directed antenna is extended by a relatively short high-frequency cable or the like to a position where no buildings or the like are present between the mobile station-directed antenna and the base station-directed antenna-this ensures solving the blind-zone problem in a closed space as in a building or underground shopping center where desirable radio waves are not be arrived in good transmission quality.

According to the above-described embodiments of the present invention, various modifications and variations may be effected by those skilled in the art within the scope of the technical ideas of the present invention. The foregoing description is merely illustrative of the present invention and should not be construed as being limitative of the invention. The present invention is restricted only by the appended claims and their equivalents.

The present invention described above in detail has such advantages as listed below.

(1) In the repeater employed for a solution of the problem of dead zone in a closed space, the high cost of laying down the coaxial cable can be cut.

(2) Since no coaxial cable needs to be laid, the time for installation of the repeater can be reduced.

(3) The repeater can be placed even at a place where no permission to lay the coaxial cable can be obtained.

(4) The repeater can be offered at low cost without using an expensive interference canceller.

(5) It is possible to provide a repeater of shorter processing delay.

(6) The service area can be extended only by increasing the number of mobile station-directed units.

What we claim is:

1. A repeater for radio communication system for eliminating a blind zone in a closed space in the radio communication system, which transmits information between a base station and a mobile station over a radio transmission medium,
said repeater comprising:
a base station-directed unit equipped with a function of transmitting a radio signal to and receiving a radio signal from said base station, and
a mobile station-directed unit equipped with a function of transmitting a radio signal to and receiving a radio signal from said mobile station,
said base station-directed unit and said mobile station-directed unit being connected via a radio transmission medium over which an electromagnetic wave signal is transmitted.

2. A repeater of claim 1, in which said radio transmission medium between said base station-directed unit and said mobile station-directed unit is so formed as to transmit said electromagnetic wave signal by the use of a communication channel different from a communication channel employed by a radio communication system, to which said repeater is provided for.

3. A repeater of claim 1, in which said radio transmission medium between said base station-directed unit and said mobile station-directed unit is so formed as to transmit said electromagnetic wave signal by use of a radio channel of a communication system different from a radio communication channel, to which said repeater is provided for.

4. A repeater of claim 1, in which said radio transmission medium between said base station-directed unit and said mobile station-directed unit is so formed as to transmit said electromagnetic wave signal by a signal path which uses an infrared-ray medium.

5. A repeater of claim 1, in which said radio transmission medium between said base station-directed unit and said mobile station-directed unit is so formed as to transmit said electromagnetic wave signal by a signal path which uses an optical wireless medium.
